(19) United States
(12) Patent Application Publication
(10) Pub. No.: US 2026/0118161 A1
(43) Pub. Date: Apr. 30, 2026

(54) Distributed Fiber-Optic Infrastructure

(71) Applicants: Joshua E. Carter, Alexandria, VA (US); Christopher Andrew Good, JR., Fredericksburg, VA (US)

(72) Inventors: Joshua E. Carter, Alexandria, VA (US); Christopher Andrew Good, JR., Fredericksburg, VA (US)

(73) Assignee: United States of America, as represented by the Secretary of the Navy, Arlington, VA (US)

(21) Appl. No.: 18/925,109

(22) Filed: Oct. 24, 2024

(51) Int. Cl. G01H 9/00

(52) U.S. Cl. CPC G01H 9/004

(57) ABSTRACT

A sensory network is provided for monitoring a physical condition within a confinement having edges. The network includes a fiber optic cable, a sensory load, a distributed sensing modulator, a database, a process module, a comparator module and a monitoring receiver. The cable extends along the edges of the confinement. The sensory load feeds into the cable. The modulator receives the load from the cable and produces a measurement signal. The database saves the measurement signal as a prior signal. The process module converts one of the measurement and prior signals into an associated feature vector. The comparator module distinguishes between measurement and prior feature vectors as a difference. The monitoring receiver for physically responding to the difference that deviates from an accepted value regarding the condition.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The invention relates generally to artificial networks. In particular, the invention relates to a sensory network that employs fiber optic cables to provide sensory information regarding condition of a contained region to be monitored.

Conditions aboard a naval vessel or land-based building can degrade into hazards in the absence of continuous monitoring. For example, a spark that initiates combustion in an enclosed and unoccupied room can in the presence of flammable material degenerate into deadly conflagration, thereby causing considerable damage before detection and appropriate mitigation commences.

### SUMMARY

Conventional networks yield disadvantages addressed by various exemplary embodiments of the present invention. In particular, various exemplary embodiments provide a sensory network for monitoring a physical condition within a confinement having edges. The network includes a fiber optic cable, a sensory load, a distributed sensing modulator, a database, a process module, a comparator module and a monitoring receiver.

The cable extends along the edges of the confinement. The sensory load feeds into the cable. The modulator receives the load from the cable and produces a measurement signal. The database saves the measurement signal as a prior signal. The process module converts one of the measurement and prior signals into an associated feature vector.

The comparator module distinguishes between measurement and prior feature vectors as a difference. The monitoring receiver for physically responding to the difference that deviates from an accepted value regarding the condition. Additional embodiments alternatively provide for the signals to correspond to acoustic, stress and temperature sensor information.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIG. 1 is a block diagram view of an exemplary sensory network;

FIG. 2 is a physical representational view of an enclosure equipped with fiber optic cabling for exemplary sensing;

FIG. 3 is a graphical view of photon scattering by Raleigh, Brillouin and Raman modes;

FIG. 4 is a graphical view of Stokes and anti-Stokes frequency shift for Raman scattering at an interrogation wavelength;

FIG. 5 is a directional process view of acoustic and/or vibrational perturbation response; and

FIG. 6 is a directional process view of temperature and/or shape sensing response.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

In accordance with a presently preferred embodiment of the present invention, the components, process steps, and/or data structures may be implemented using various types of operating systems, computing platforms, computer programs, and/or general purpose machines. In addition, artisans of ordinary skill will readily recognize that devices of a less general purpose nature, such as hardwired devices, may also be used without departing from the scope and spirit of the inventive concepts disclosed herewith. General purpose machines include devices that execute instruction code. A hardwired device may constitute an application specific integrated circuit (ASIC), a field programmable gate array (FPGA), digital signal processor (DSP) or other related component.

The disclosure generally employs quantity units with the following abbreviations: length in meters (m), mass in grams (g), time in seconds(s), angles in degrees) (°, force in newtons (N), temperature in kelvins (K), energy in joules (J), and frequencies in hertz (Hz). Supplemental measures can be derived from these, such as density in grams-per-cubic-centimeters (g/cm³), moment of inertia in gram-square-centimeters (kg-m²) and the like.

When laser light interacts with a medium, such as a fiber optic cable, photon particles deflect elastically and inelastically. With the application of distributed fiber optic sensing (DFOS), a sensing interrogator sends temporally short pulses down the fiber cable and molecular inhomogeneities within the glass provide the aforementioned collisions and the resulting light-matter interactions are called scattering. This scattering phenomena are omni-directional, but a small portion couples back to the interrogator where signal processing analyzes the scattered reflection for correlation to environmental changes.

An exemplary Fiber Optic Nervous System has been conceived for the purpose of collecting and interrogating data from an environment within an established three dimensional (3D) boundary created by a fiber optic network. This fiber optic network employs durable fiber optic sensing (DFOS)-enabled cables for high resolution strain and temperature.

Environmental data are used by the system to establish normal operation and conditions for an infrastructure, such that deviations from the norm can be detected and/or anticipated. Normal conditions are derived from a time series of collected acoustic, temperature, and structural norms of an environment. Exemplary embodiments employ the aforementioned data to produce an artificial “nervous system” for processing responses to stimuli.

This Nervous System is a constant feedback loop that continuously collects and interrogates backscattered light information from its fiber optic network to create a learned understanding of normal operation in order to discern and locate anomalous events within an infrastructure. The sensing apparatuses work in tandem with data interrogation and characterization methods such that an artificial intelligence (AI)-based pattern recognition system (PRS) will discern anomalous activity and inform an operator of environmental or mechanical changes through its user interface (UI).

The disclosed system provides any asset the capability to diagnose anomalous events within its boundary with a tailorable degree of spatial resolution, varying slightly depending on the dominant sensing method on the localization of the event. For example, a fire would be localized dominantly by the temperature change associated with the event, whereas the degradation of machinery would be localized based on a change in acoustic profile.

The objective of exemplary embodiments is an installable “nervous system” for physical infrastructures, capable of characterizing an environment with tailorable spatial and contextual accuracy by learning through the PRS architecture. In terms of applicability, this disclosure has utility in fields of infrastructure security and monitoring to include but not limited to military installations, naval vessels, buildings, data centers, factories, condition-based maintenance, fire detection, intrusion detection and biometrics.

Rayleigh scattering is the predominantly elastic scattering of light by particles internal to the fiber cable 240 that are smaller than the light's wavelength. This form of scattering is identifiable by returned photons of the same frequency as the interrogator pulse. Raman scattering is a nonlinear process where inelastic collisions occur between the interrogator photons and the fiber optic medium.

This changes the nature of the interrogated medium, and these are reflected in the induced backscatter. This is identifiable through the interrogation of frequency shifted backscatter. When compared to incident photons, Raman scattering reveals vibrational energy pertaining to temperature deviation and thus conveys thermal information about the ambient environment.

Generally, this means that the backscattered light is frequency shifted ±13 THz, as a vibration or temperature change perturbs the fiber and changes the properties of the medium. This change either results in a change in optical path length which manifests as a phase change, or as a change in the frequency shift of the Raman scattered light. Note that the Brillouin scattering functions similarly to Raman but on a smaller order of frequency shift around ±10 GHz.

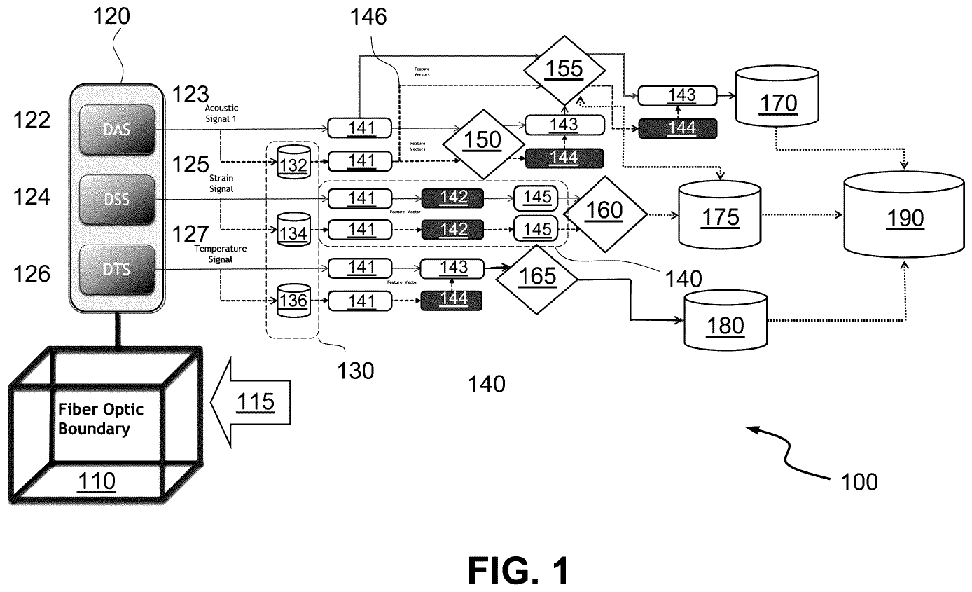

FIG. 1 shows a block diagram view 100 of data processing within a fiber optic boundary 110 that receives fiber optic information 115 and connects to a digital signal modulator 120. Components in the modulator 120 include a digital acoustic signal (DAS) 122 that connects to acoustic 123, a digital strain signal (DSS) 124 that connects to strain, and a digital temperature signal (DTS) 126 that connects to thermal sensor 127. The signals 123, 125 and 127 are stored in respective databases 130 for acoustic 132, strain 134 and temperature 136. These signals are submitted to process modules 140, including feature extraction 141, conversion to 3D shape 142, pattern classification 143, model training 144 and 3D orientation 145.

The modules 140 from the databases 130 release feature vectors 146 to comparison operators, including demodulation optical waveforms 150, processing schema 155 for array signals, acoustic location of vibration source in 3D space, comparison for shape anomaly 160 and interpolation of longitudinal data 165. The waveform demodulation 150 provides inputs to pattern classification 143 and model training 144 modules for input to the schema 155, which provides pattern classification 143 and model training 144 for storage in acoustic classification and localization database 170. These comparison operators 150, 155 and 160 produce information as differences between signals from the DTOS modulator 120 and signals from the databases 130.

A fiber network 3D orientation database 175 receives results from the shape comparison 160. Temperature gradient database 180 receives interpolation data 165. Information from databases for classification 170, orientation 175 and gradient 180 are provided to a display 190 (or other receiver) for environmental modeling analysis and for initiating appropriate response from information in the databases 170, 175 and 1801. This information constitutes deviation from schema 155 between that deviate from accepted parameters, such as activation of an alarm or a mitigation instrument.

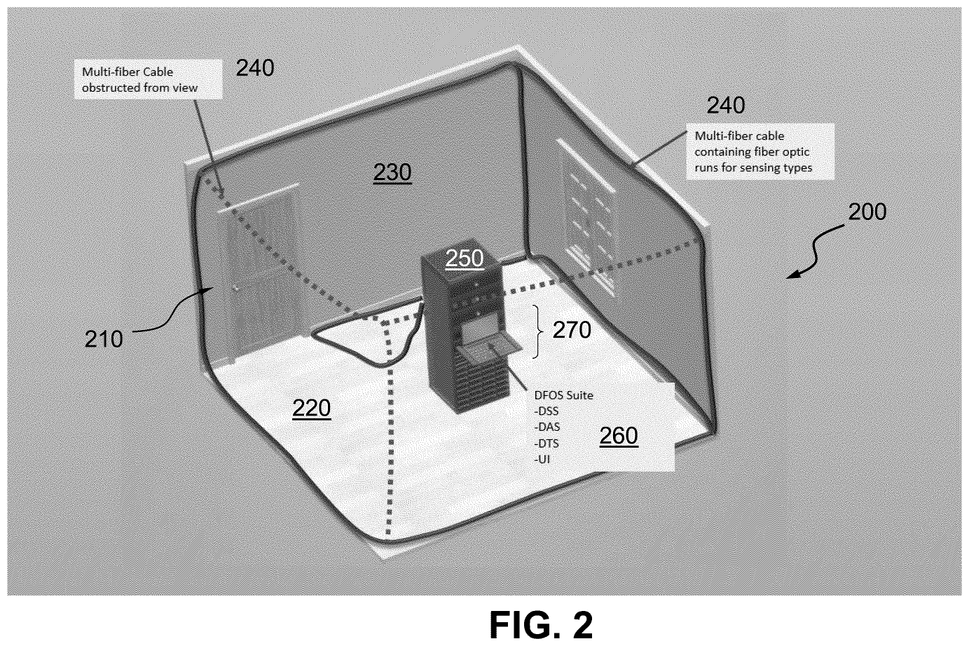

FIG. 2 shows a physical representational view 200 of an enclosed room 210 as an exemplary environment. The room 210 includes a floor 220 and walls 230. Multi-fiber cables 240 are disposed along the edges of the floor 220 and walls 230. The floor 220 supports a monitoring platform 250 loaded with a software package 260 and accessible by an operator via an interface console 270 that serves as the display 190.

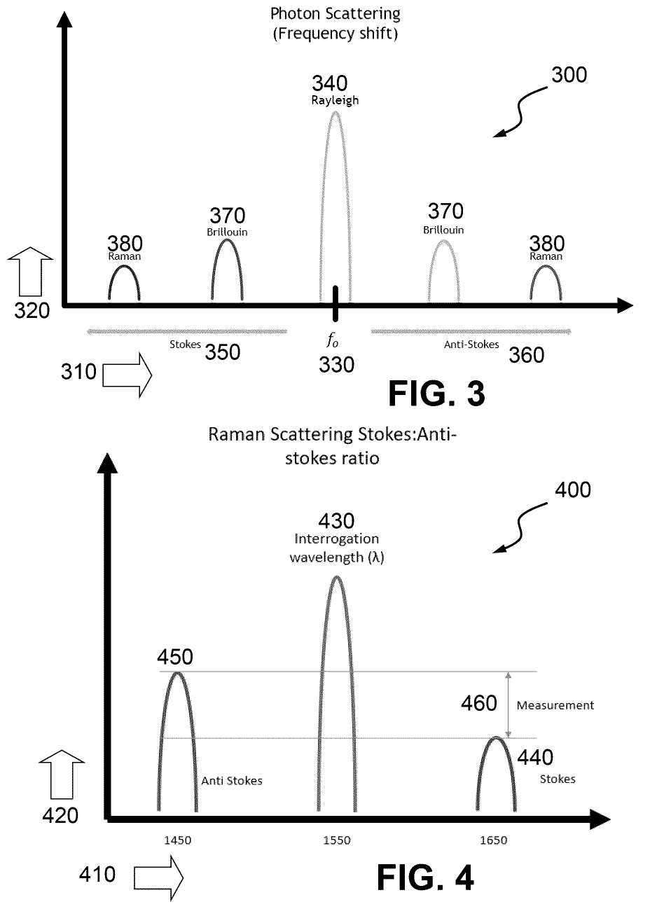

FIG. 3 shows a graphical view 300 of photon scatter frequency. Frequency 110 is denoted as the abscissa, while amplitude 320 is denoted as the ordinate, both unscaled. A harmonic frequency f, 330 corresponds to Rayleigh scattering 340. Lower frequencies (and thus longer wavelengths) correspond to Stokes scattering 350, while higher frequencies (and thus shorter wavelengths) correspond to anti-Stokes scattering 360. Both Brillouin 370 and Raman 380 scattering flank the Rayleigh 340 with attenuated amplitudes.

Scattered light above the frequency of the incident photon is called “anti-Stokes” scattering 450 while a negative frequency shift is called “Stokes” scattering 440. Because of the frequency shift or lack thereof of these scattering mechanisms, the backscatter component of interest can be isolated via optical bandpass filtering.

Rayleigh scattering 340 is the core physical concept that enables optical time-domain reflectometry (OTDR) to operate. The deployment of an OTDR trace produces a profile from backscattered light. Monitoring and analyzing the scattering profile of an optical fiber provides a characterization of the fiber and its molecular orientation. The profile provides a unique nanoscale feature signature of the fiber 240 in a longitudinal manner. This means with each trace, every point in the fiber provides a map of its position and current molecular orientation.

The relation of backscatter to longitudinal position is accomplished through calculating the delay induced by the round-trip propagation time of incident and scattered photons. This is depicted best through the following relation:

$$Δ τ = \frac{{n}_{eff , out} + {n}_{eff , in}}{c} \cdot z , \qquad ( 1 )$$

where Δτ is round trip propagation time τ, n_{eff} is group index in which out relates to sensing signal and in relates to backscatter, c is speed of light, z is longitudinal distance.

The shape of an optical time-domain reflectometer (OTDR) trace changes as the fiber experiences perturbing environmental shifts. Specifically quantifiable changes like temperature, stress, acoustic profile, vibration, and pressure along the fiber are detectable and locatable continually through this technique. Specially engineered fiber types exist that specifically target increasing the sensitivity of such measurements. This class of specialty fiber types utilize dopants, materials, coatings etc. to increase backscattering phenomena or other pertinent characteristics to produce higher fidelity.

Three DFOS modulators 120 are described within this disclosure, and thus their background is provided. Distributed temperature sensors (DTS) 126 have demonstrated successful implementation in numerous commercial applications such as fire detection and temperature alarm in tunnels of railways, highways and underground electrical lines. There are many variations of OTDR traces that yield accurate temperature readings. The predominant two types of traces for DTS applications utilize Raman optical time-domain reflectometry (ROTDR), or Raman optical frequency-domain reflectometry (ROFDR). In both methods, temperature estimation uses the ratio of Raman 380 anti-Stokes 360 to Stokes 350 intensities.

FIG. 4 shows a graphical view 400 of Raman reflectometry ratio in terms of wavelength 410 that serves as the abscissa, while unscaled amplitude 420 denotes the ordinate regarding signal strength. The infrared interrogation wavelength 430 centered at 1550 nm within the fiber optic cable 240 yields anti-Stokes backscatter reflections 440 at shorter wavelengths of 1450 nm and Stokes backscatter reflections 450 at longer wavelengths of 1660 nm. The difference in amplitude 460 between anti-Stokes and Stokes scattering provides a measurement value. Note that wavelength and frequency have an inverse relationship so shorter wavelength value corresponds to higher frequency.

A mathematical description of this ratio R is given by the following relation:

$$R ( T ) = \frac{{P}_{AS}}{{P}_{S}} ∝ \frac{{λ}_{S}}{{λ}_{AS}} exp ( \frac{h Δ v}{{k}_{b} T} ) , \qquad ( 2 )$$

where T is temperature, P_{S} is power of Stokes light 350, P_{AS} is power of anti-Stokes light 360, λ_{S} is Stokes light wavelength, λ_{AS} is anti-Stokes light wavelength, h is Planck's constant, Δv is Raman frequency shift and k_{b} is Boltzmann constant.

Raman scattering 380 is an ideal methodology for detecting temperature change because of its insensitivity to both strain and vibration, hence its deployment in this system. Contrarily, phase-sensitive optical time-domain reflectometry (φ-OTDR) relies on the monitoring of local phase variation of Rayleigh backscatter 340. Such φ-OTDR schemes usually come in one of two forms, direct and coherent detection. Direct detection constitutes the identification of local changes in the power of the backscattered signal over time, while coherent detection deploys a reference signal allowing both the phase and amplitude components of vibrational perturbation to be extracted. The backscattered power is not directly related to the magnitude of the perturbing signal but the phase component is. This enables perturbing signal reconstruction and that reconstruction is one of the core concepts driving the acoustic characterization and localization capabilities the infrastructure nervous system is predicated on.

Distributed acoustic sensors (DAS) 122 have received a lot of attention from both industry and academia in recent years due to their great potential for third-party intrusion detection, seismic detection and pipeline monitoring. A distributed acoustic sensor (DAS) 122 has the capability of registering faint vibrations with high spatial resolution along a sensing fiber. Additionally, acoustic waves can be detected and reconstructed from phase information of backscattered light.

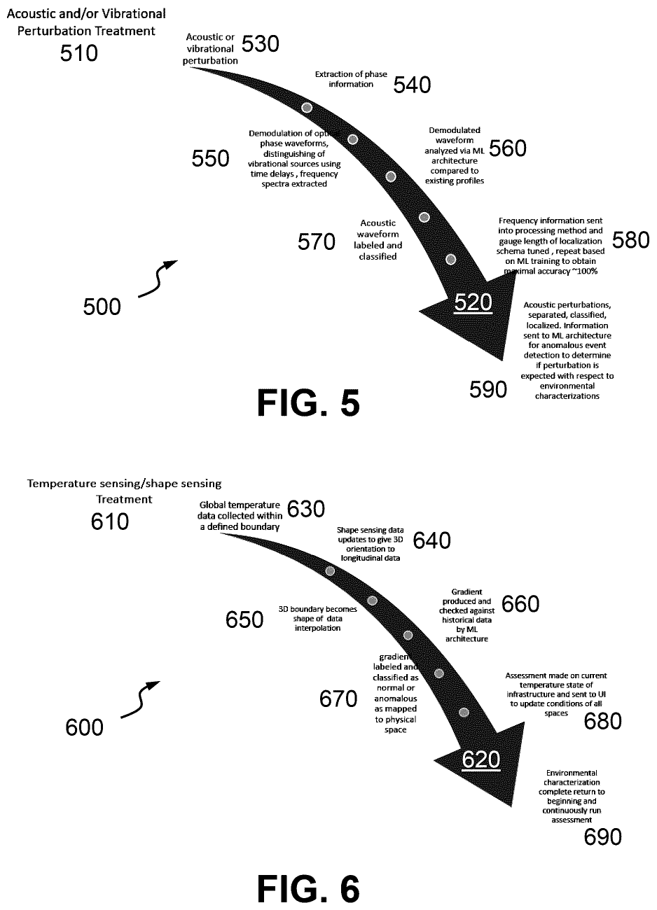

FIG. 5 shows a representational view 500 of acoustic and/or vibrational perturbation treatment 510 along a trajectory 520. This begins with acoustic or vibrational perturbation 530, followed by extraction of phase determination 540. This leads to process 550 of demodulation of optical phase waveforms, distinguishing of vibrational sources using time delays, frequency spectra extracted.

This is followed by process 560 of demodulated waveform analyzed via machine learning (ML) architecture compared to existing profiles, and then acoustic waveform labeled and classified 570. Then, frequency information 580 sent into processing method and gauge length of localization scheme tuned, repeat based on ML training to obtain maximal accuracy. Finally, process 590 for acoustic perturbation, separated, classified localized, information sent to ML architecture for anomalous event detection to determine whether perturbation is expected with respect to environmental characterizations.

FIG. 6 shows a representational view 600 of temperature sensing/shape sensing treatment 610 along a trajectory 620. This begins with global temperature data 630 collected within defined boundaries 210, followed by shape sensing data updating 640 to provide 3D orientation to longitudinal data. This leads to process 650 3D boundary becomes shape of data interpolation.

This is followed by process 660 of gradient produced and checked against historical data by ML architecture, and then process 670 for gradient labeled and classified as normal or anomalous as mapped to physical space. Then, assessment on infrastructure temperature rate 680 sent into processing UI 260 to update condition of all spaces. Finally, environmental characterization 690 provides for complete return to beginning and continuously run assessment.

The predominant methods for interrogating a fiber for environmentally induced acoustic waveforms are OTDR, optical frequency domain reflectometry (OFDR), and φ-OTDR. The working principle of DAS 122 is based on Rayleigh scattering and φ-OTDR. Note that φ relates to phase. This utilizes an interference effect of Rayleigh backscattering 340 of different profiles within the pulse width. The most prominent DAS 122 is a coherent detection scheme that enables the extraction of both intensity and phase information. Utilizing signal analysis, the intensity and phase information provides amplitude and frequency data in real time on sounds and vibrations perturbing the fiber cable 240.

Distributed shape sensors are generally used in the medical field and suffer from a lack of adoption and development for longer runs (>1 km). However, Brillouin scattering 370 demonstrates the capability for continuous strain measurements over long distances while sacrificing spatial resolution. Brillouin based shape sensing is a strain measurement technique that utilizes the Brillouin backscatter 370 to determine the curvature and shape of a structure 210.

In the exemplary approach, a sensing fiber cable 240 is embedded or attached along a structure of interest. This fiber cable 240 acts as a continuous strain sensor 124, capable of measuring strain changes along its entire length. These strain distributions are quantified by analyzing the frequency shift of the scattered light. This distribution can then be used to calculate the curvature and shape of the structure. The resolution of these systems is generally in the centimeter-meter regimes.

The local curvature of a fiber optic cable 240 can be determined if two or more sensing lines are placed inside the same geometric run in close proximity, perhaps even sharing a fiber cable 240. The arrangement of sensing lines must ensure they have the same path geometry, such that the strain values of each can be utilized together to derive curvature characteristics along the run.

These characteristics arise due to bending orthogonal to the sensing direction. This idea is based on elastic bending theory where the deflection w as a function of longitudinal space x can be described by:

$$w ( x ) = \int \int \frac{M ( x )}{E \cdot {I}_{y}} = \int \int κ ( x ) , \qquad ( 3 )$$

where w is deflection as a function of cable length x, M is bending moment, E is modulus of elasticity, and I_{y} is moment of inertia (in the bending direction).

Moreover, the deflection w can be doubly integrated from local curvature κ as a function of cable length x, which can be further defined by:

$$κ ( x ) = \frac{1}{R ( x )} = \frac{{ε}_{top ( x )} - {ε}_{bottom ( x )}}{d ( x )} , \qquad ( 4 )$$

where R is bending radius, εₜₒₚ and ε_{bottom} are strain values for respective top and bottom layers, and d is distance between sensors.

Local curvature x and can be further redefined by:

$$κ ( x ) = \frac{1}{R ( x )} = \frac{{ε}_{top ( x )} - {ε}_{bottom ( x )}}{d ( x ) \cdot ( 1 + \overline{ε} ( x ) )} , \qquad ( 5 )$$

where ε̅ is mean strain of both sensing layers, expressed as:
and

$$\overline{ε} ( x ) = \frac{1}{2} ( {ε}_{top ( x )} + {ε}_{bottom ( x )} ) . \qquad ( 6 )$$

The Long short-term memory (LSTM) network provides another key concept undergirding exemplary embodiments. LSTM represents a type of recurrent neural network architecture designed to address the limitations of traditional neural networks in capturing long-term dependencies. LSTMs comprise recurrently connected memory blocks, each containing memory cells and multiplicative units called gates. These gates, including input, output, and forget gates, regulate the flow of information within these cells.

The architecture ensures constant error flow and protects memory contents from perturbation. LSTMs can bridge long time lags by preserving and accessing relevant information, enabling effective learning and prediction. The simple LSTM presents a commonly used architecture that performs well on various datasets. This enables the independent tuning of hyper parameters such as the learning rate and network size, facilitating efficient model optimization. Most importantly, LSTMs provide a powerful mechanism for capturing and utilizing information over extended time periods, making them a valuable tool with respect to this application where time series prediction is paramount.

The concept of DFOS modulators 120 combines with a LSTM approach for data processing enables an environment to learn to distinguish between normal and abnormal occurrences and predict changes. This can provide notification of personnel of any existing or potential dangers. This “nervous system” constitutes a constant feedback loop that continuously collects and interrogates backscattered light information from its fiber optic network to discern and locate anomalous or threatening events within a structure. This provides any infrastructure the capability to diagnose anomalous events with an extreme degree of spatial resolution.

DFOS 120 possesses all of the normal advantages of fiber optics over conventional electric sensing and data transmission techniques, including immunity to electromagnetic interference, geometric flexibility, and ability for multiplexing. The DFOS 120 has the advantage of continuous nature of its datasets. This volume of data enables the construction of a robust pattern recognition system (PRS) LSTM architecture capable of characterizing a physical system with extreme spatial and contextual accuracy by receiving input through a machine learning algorithm.

In future years, distributed sensing coupled with a PRS can expand Its acceptance and adoption as its unique and powerful capabilities have important implications and applications in environmental monitoring, safety, and security systems, marine and aerospace structures, civil engineering, and many other sectors. Given the nature of this technology, its fullest maturity provides extreme capability.

This convergence of emergent technology, extreme capability, and existing infrastructure is the point of intrigue with respect to DFOS 120 and intelligent PRS. The marriage of all of these ideas culminates in a nervous system that enables an infrastructure to be environmentally and artificially aware of its own condition. This awareness lends itself to the creation of a new generation of buildings, vehicles, plants, etc. that utilize active monitoring towards condition based and/or preventative maintenance, and a litany of other operations.

This disclosure relates to a device and/or procedure for the deployment of optical fiber 240 based sensing systems in a synchronized manner to produce a three dimensional enclosure/boundary condition towards the characterization of an enclosed environment/infrastructure. This boundary condition also includes/refers to a fiber optic matrix that consists of fiber cable 240 that surrounds and/or penetrates an environment in a grid-like orientation or simply as a three-dimensional (3D) boundary 210.

The exemplary fiber optic structure 210 can be interrogated via a distributed fiber optic sensing system to create a “nervous system” within its deployed infrastructure. The techniques by which these sensing systems are deployed in tandem and the data from these apparatuses are processed provide the benefit from exemplary embodiments. In essence, the resulting “nervous system” enables constant monitoring for safety, preventative maintenance, fire detection, power cable monitoring, structural and dynamic monitoring, acoustics, biometrics and constant assessment of system/machine functionality or gaps of functionality within its confines.

The disclosed exemplary embodiments include the following components:
Distributed Acoustic sensing system (DAS) 122, including fiber-optic microphone arrays for localization and classification, as well as ML architecture for support of both localization and classification.
Distributed Temperature System (DTS) 126, including temperature gradient software, ML architecture for normal-vs-anomalous classification of gradient.
Distributed Shape Sensing Architecture (DSSA) via strain measurements 124, including shape information to strengthen localization methodologies for both temperature gradient production and acoustic source location with respect to fiber array. Additionally, distributed shape sensing converts longitudinal DFOS 120 plots of data values to 3D coordinates, such that acquired data are interpolated and/or correlated to locations in 3D space.
Machine Learning Method and Preventive Maintenance Monitoring, including long short-term memory (LSTM) network integrates data from the acoustic 122, temperature 126 and shape-sensing 124 systems, learning from the variations, with the network learning the normal environmental patterns within the infrastructure to detect anomalies that indicate potential concerns, monitoring the state of the infrastructure and predict future states, enabling predictions to apply preventive actions, such as maintenance or inspections, reducing the risk of catastrophic failure and reducing maintenance cost by flagging minor problems before they exacerbate from neglect.
User Interface (UI) 260 for displaying relevant data (including temperature gradient) and conclusions to personnel

The above components operate in conjunction to facilitate the processes necessary for the functioning of exemplary embodiments. Each sensor system contributes to the overall functioning and delivers useful data for analysis by the artificial intelligence (AI) system.

The Distributed Acoustic Sensing (DAS) 122 system is a primary component, with the Fiber Optic microphone arrays being fundamental to the localization and classification of sounds within the infrastructure. These systems are particularly adept at detecting changes in the acoustic profile, such as machinery degradation, abnormal sounds that could signify intruders, and the unique acoustic signatures of hazards or other similar events. Also, these microphone arrays would be utilized for biometric information for personnel. Machine learning supports both the localization and classification components, enabling them to distinguish normal sounds from potential threats.

The Distributed Temperature System (DTS) 126 functions to monitor the temperature throughout the infrastructure. It is combined with a temperature gradient software that detects and map any changes in temperature profile across the environment. A machine learning architecture is also implemented with the DTS 126, which uses nominal and anomalous classifications of gradient to detect potential issues, such as fires or machinery overheating.

The Distributed Shape Sensing Architecture (DSSA) based on the DSS 124 assists with strengthening the localization methodologies for both the temperature gradient and acoustic source location with respect to the fiber array. The DSSA also takes longitudinal DFOS plots of data and converts them into 3D coordinates. This enables the data to be mapped to specific locations in the space, enhancing the spatial accuracy of the system.

The shape sensing system deployed utilizes Brillouin scattering 370, which means there can be longer runs for large infrastructures, but with lower spatial resolution, meaning smaller scale shape changes may not be accurately captured in very large infrastructures. To overcome this limitation, careful placement and arrangement of the fiber cable 240 to be run is crucial. Necessity may cause division of the cable 240 extension into sections for installation into multiple strain sensing units in order to produce a complete 3D model.

A robust machine learning algorithm is crucial to the integration of all sensing modalities and predictive capabilities. Such algorithm implementation can be specifically designed for time-series prediction. This machine learning component is responsible for integrating the data collected from the acoustic, temperature, and shape sensing systems, learning from the variations in this data, and making predictions about the next state of the environment within the infrastructure.

The machine learning method deployed by the exemplary Fiber Optic Nervous System is primarily based on an advanced variant of Recurrent Neural Networks (RNNs) known as Long Short-Term Memory (LSTM) networks. LSTM networks are particularly suitable for this application due to their ability to learn from sequences of data, such as the time-series data generated by the sensing systems, and produce future predictions based on learned patterns. These networks have the ability to remember and forget information over time, thereby making them an ideal choice for the task of continuous monitoring and prediction.

The LSTM network integrates data from the distributed acoustic sensing system, the distributed temperature system, and the distributed shape sensing architecture. By processing the integrated data, the LSTM network learns the normal patterns of the environment within the infrastructure, and in turn, can detect anomalies that may signify potential mechanical issues, intrusions, fire events, or other threats/abnormalities.

The LSTM network is responsible for the continuous preventative maintenance monitoring feature of the Fiber Optic Nervous System. The network constantly monitors the state of the infrastructure, learning from the data, and making predictions about future states. If the predicted state indicates a potential issue, the network can trigger a preventative action, such as maintenance or inspection. This enables the early detection of potential problems and reduces the risk of catastrophic failures, thereby extending the lifespan of the infrastructure and reducing maintenance costs.

The User Interface (UI) 260 is an important part of this system, but could be any display software enabling the UI 260 to be customized to the implementation of the infrastructure nervous system. The UI 260 denotes the mechanism that displays all the information generated by the system personnel monitoring the infrastructure. The UI 260 provides real-time data and alerts, enabling the operators to respond promptly to any detected anomalies.

This combination of distributed fiber optic sensing and predictive machine learning enables the Fiber Optic Nervous System to function as a comprehensive monitoring and preventative maintenance solution, capable of characterizing the environment within an infrastructure with extreme spatial and contextual accuracy, and continuously predicting and responding to future states for the effective management of the infrastructure.

### Advantages

Continuous Monitoring: One of the primary benefits of the system is its ability to provide continuous, real-time monitoring of the infrastructure. This offers a significant advantage over conventional methods that may require manual checks or periodic assessments. This system provides instantaneous updates and alerts, facilitating quick response to potential problems.
Tailored Spatial Resolution: The system provides highly detailed and accurate spatial information about the monitored infrastructure. This enables the precise location of potential issues, making it easier to take effective and targeted remedial actions.
AI-Powered Analysis: The inclusion of machine learning and artificial intelligence within the system enables more efficient and accurate interpretation of the vast amounts of data generated by the sensors. The system can distinguish between normal and abnormal patterns, thus minimizing false alarms and improving the reliability of the alerts.
Interdisciplinary Applications: The system is versatile and can be applied in various fields such as military installations, naval vessels, data centers, factories, buildings, and more. This provides a universally beneficial technology with wide-ranging applications.
Flexible Implementation: Given the fiber optic nature of the system, the system offers geometric flexibility, enabling tailoring to different shapes and sizes of infrastructures. This enables the system to be applied to a wide variety of infrastructures, from small buildings to large industrial complexes.
Analysis: The system integrates multiple sensing modalities (acoustic, temperature, and shape sensing), enhancing the comprehensiveness and accuracy of the environmental analysis. This not only enables better detection and localization of anomalies but also provides a more holistic understanding of the environment.
Preventive Maintenance: With its constant monitoring and accurate detection of anomalies, the system offers a powerful tool for preventive maintenance. By identifying potential issues before they become significant problems, the system facilitates damage prevention, extend the lifespan of the infrastructure, and reduce maintenance costs.
Improved Safety: By providing real-time alerts on potential hazards such as fires or intruders, the system significantly improves the safety of the infrastructure. This can not only protect the physical infrastructure and any assets within it but also can protect the lives of any people who may be in the infrastructure.
Bragg Grating Sensors: Fiber Bragg Grating (FBG) sensors are a common alternative to DFOS 120 for distributed sensing. They operate based on the principle of light reflection from periodic changes in the refractive index within the fiber. These sensors are particularly useful for strain and temperature measurements.
Interferometric Fiber-Optic Sensors: These sensors operate based on the principle of interference of light. They can be highly sensitive and are used for various measurements such as temperature, strain, and vibration.
Vibration Analysis: Traditional vibration analysis techniques can be employed to detect anomalies in machinery or structures. Vibration sensors are strategically placed on the infrastructure to monitor changes in vibration patterns, which can indicate potential faults or malfunctions.
Image Processing: Visual monitoring systems, such as surveillance cameras or thermal imaging cameras, can be utilized to detect anomalies in the infrastructure. Image processing techniques can analyze the captured images or videos to identify any unusual activities or changes in the environment.
Electrical Monitoring: Electrical monitoring systems can track electrical parameters, such as voltage, current, and power consumption, to identify abnormalities or inefficiencies in electrical systems. Deviations from normal electrical behavior can indicate faults, overloads, or energy wastage.
Environmental Sensors: Utilizing a range of environmental sensors, including humidity, air quality, radiation, or traditional temperature sensors, can provide comprehensive monitoring of the infrastructure's surroundings. Changes in environmental conditions can indicate potential risks or abnormalities.

Alternatives: While the Fiber Optic Nervous System employs a specific approach for data collection and interrogation, there exist other techniques and methodologies that could also be considered. This section outlines some alternative detection schemes and machine learning methodologies.
Bragg Grating Sensors: Fiber Bragg Grating (FBG) sensors are a common alternative to DFOS 120 for distributed sensing. They operate based on the principle of light reflection from periodic changes in the refractive index within the fiber. These sensors are particularly useful for strain and temperature measurements.
Interferometric Fiber-Optic Sensors: These sensors operate based on the principle of interference of light. They can be highly sensitive and are used for various measurements such as temperature, strain, and vibration.
Vibration Analysis: Traditional vibration analysis techniques can be employed to detect anomalies in machinery or structures. Vibration sensors are strategically placed on the infrastructure to monitor changes in vibration patterns, which can indicate potential faults or malfunctions.
Image Processing: Visual monitoring systems, such as surveillance cameras or thermal imaging cameras, can be utilized to detect anomalies in the infrastructure. Image processing techniques can analyze the captured images or videos to identify any unusual activities or changes in the environment.
Electrical Monitoring: Electrical monitoring systems can track electrical parameters, such as voltage, current, and power consumption, to identify abnormalities or inefficiencies in electrical systems. Deviations from normal electrical behavior can indicate faults, overloads, or energy wastage.
Environmental Sensors: Utilizing a range of environmental sensors, including humidity, air quality, radiation, or traditional temperature sensors, can provide comprehensive monitoring of the infrastructure's surroundings. Changes in environmental conditions can indicate potential risks or abnormalities.

Alternative machine learning methods: include various techniques.
Supervised Learning: This approach uses labeled data for training the machine learning model, perhaps suitable for environments where sufficient labeled data are available or can be created. Methods such as Support Vector Machines (SVM) or Decision Trees could be employed.
Semi-Supervised Learning: This is a hybrid approach that uses both labeled and unlabeled data for training. This method might be suitable when labeled data are limited.
Transfer Learning: This method leverages pre-existing models that have been trained on large data sets to achieve high performance with relatively less computational resources. This might be suitable in situations where computational power or time is limited.
Reinforcement Learning: This approach uses a system of rewards and punishments to train the model. It might be suitable for dynamic environments where the model needs to adapt to changing conditions.
Ensemble Learning: This method combines multiple models to make predictions to improve the robustness and stability of the system. Methods such as Random Forest or AdaBoost could be implemented.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A sensory network for monitoring a physical condition within a confinement having edges, said network comprising:
a fiber optic cable that extends along the edges of the confinement;
a sensory load that feeds into said cable;
a distributed fiber optic sensing (DFOS) modulator that receives said load from said cable and produces a measurement signal;
a database for saving said measurement signal as a prior signal;
a process module for converting one of said measurement and prior signals into an associated feature vector;
a comparator module for distinguishing between measurement and prior feature vectors as a difference; and
a monitoring receiver for physically responding to said difference that deviates from an accepted value regarding the condition.

2. The network according to claim 1, wherein said DFOS modulator includes at least one sensor for acoustic, stress and temperature signals.

3. The network according to claim 1, wherein said process module includes at least one of feature extraction, three dimensional shape conversion, pattern classification, model training operation and orientation.

4. The network according to claim 1, wherein said process module employs machine learning architecture.

5. The network according to claim 1, wherein said process module employs long short-term memory for data integration.

6. The network according to claim 1, wherein said comparator module evaluates said feature vector for Stokes and anti-Stokes frequency shift between at least one of Rayleigh, Brillouin and Raman scattering.

7. The network according to claim 1, wherein said comparator module compares said feature vector at an interrogation wavelength for Raman scattering for measuring signal strength ratio between Stokes and anti-Stokes frequency shift.

8. The network according to claim 1, wherein said receiver responds by activating a mitigation instrument regarding the condition.

9. A computer-implemented networking method for monitoring a physical condition within a confinement having edges, said method comprising:
extending a fiber optic cable along the edges of the confinement;
feeding a sensory load into said cable;
receiving said load from said cable to a distributed fiber optic sensing (DFOS) modulator to produce a measurement signal;
saving said measurement signal into a database as a prior signal;
processing one of said measurement and prior signals into an associated feature vector;
comparison distinguishing between measurement and prior feature vectors as a difference; and
physically responding to said difference that deviates from an accepted value via a monitoring receiver.

10. The method according to claim 9, wherein said measurement signal comprises at least one of acoustic, stress and temperature signals.

11. The method according to claim 9, wherein said processing employs machine learning architecture.

12. The method according to claim 9, wherein said processing employs long short-term memory for data integration.

13. The method according to claim 9, wherein said processing comprises at least one of feature extracting, three dimensional shape converting, pattern classifying, model training and orientating.

14. The method according to claim 9, wherein said distinguishing comprises evaluating said feature vector for Stokes and anti-Stokes frequency shift between at least one of Rayleigh, Brillouin and Raman scattering.

15. The method according to claim 9, wherein said distinguishing comprises comparing said feature vector at an interrogation wavelength for Raman scattering for measuring signal strength ratio between Stokes and anti-Stokes frequency shift.

16. The method according to claim 9, wherein said responding by said monitor includes activating a mitigation instrument regarding the condition.
